(19) United States
(12) Patent Application Publication
(10) Pub. No.: US 2008/0025641 A1
(43) Pub. Date: Jan. 31, 2008

(54) Apparatus and method to rotate a bitmap image

(75) Inventor: Sung-myun Lee, Seoul (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 11/705,512

(22) Filed: Feb. 13, 2007

(30) Foreign Application Priority Data
Jul. 25, 2006 (KR) 2006-69613

(51) Int. Cl. G06T 3/60

(52) U.S. Cl. 382/296

(57) ABSTRACT

A bitmap image conversion apparatus and a method for rotating a bitmap image are. The apparatus includes an edge information calculator to calculate information on an edge of a rotated bitmap corresponding to a predetermined edge of a source bitmap using bitmap information, a line information calculator to calculate line information to generate the rotated bitmap using the edge information of the rotated bitmap, and a bitmap generator to generate a final rotated bitmap using the edge information of the rotated bitmap and the line information. Accordingly, the calculation rate of bitmap image rotation can be enhanced.

### CROSS-REFERENCE TO RELATED APPLICATIONS

This application claims priority under 35 U.S.C. §119(a) of Korean Patent Application No. 10-2006-0069613, filed in the Korean Intellectual Property Office on Jul. 25, 2006, the entire disclosure of which is incorporated herein in its entirety by reference.

### BACKGROUND OF THE INVENTION

1. Field of the Invention

The present general inventive concept relates to an image conversion apparatus and a method thereof. More particularly, the present general inventive concept relates to an image conversion apparatus which adopts Bresenham's line algorithm to rotate and image, and an image conversion method thereof.

2. Description of the Related Art

Bitmap images need to be rotated to output a desired image in graphics applications, game programs, drivers for image processing devices, firmware software and hardware ASIC.

FIG. 1 illustrates a conventional bitmap rotation system, and FIG. 2 illustrates a coordinates conversion error in the conventional bitmap rotation system.

The conventional bitmap rotation system in FIG. 1 includes a source bitmap 10, a rotation engine 20, an interpolation engine 30 and a rotated bitmap 40.

The rotation engine 20 calculates a new set of coordinates (X,Y) from the coordinates (X,Y) of each of a plurality of pixels of the source bitmap 10 using Equation 1 to generate the rotated bitmap 40, where T is the rotation angle.

$$( \begin{matrix}X \\ Y\end{matrix} ) = ( \begin{matrix}Cos ( T ) - Sin ( T ) \\ Sin ( T ) Cos ( T )\end{matrix} ) ( \begin{matrix}x \\ y\end{matrix} ) \qquad [ Equation 1 ]$$

Equation 1 can be expressed as Equation 2.

X=x×Cos(T)−y×Sin(T)

Y=x×Sin(T)+y×Cos(T) [Equation 2]

Equation 1 and Equation 2 calculate new coordinates using counterclockwise rotation. However, since a conventional display device or a print device uses clockwise rotation, a clockwise coordinates conversion equation should be used. Equation 3 illustrates a clockwise coordinates conversion equation.

X=x×Cos(T)+y×Sin(T)

Y=−x×Sin(T)+y×Cos(T) [Equation 3]

Coordinates mapped to the rotated bitmap 40 can be acquired by applying Equation 3 to the pixels constituting the source bitmap 10. Accordingly, the rotated bitmap 40 can be generated by reading a pixel of the source bitmap 10, calculating new coordinates and storing the pixel value of the source bitmap 10 with the new coordinates.

A bitmap exists in an integer coordinates system, but Cos(T) and Sin(T) used in a coordinates conversion equation such as Equation 3 are generally real numbers. Accordingly, values used when calculating new coordinates perform real number calculation, so the rate of digital calculation is considerably reduced.

Additionally, as calculated new coordinates also contain real numbers, not all the coordinates of each pixel of the source bitmap 10 are mapped to the rotated bitmap 40, and a plurality of pixels of the source bitmap 10 may be mapped to one pixel of the rotated bitmap 40, as illustrated in FIG. 2.

In FIG. 2, if two pixels of the source bitmap 10 are mapped to one pixel of the rotated bitmap 40, the rotated bitmap 40 has a black pixel which is not mapped from any pixels of the source bitmap 10.

The interpolation engine 30 applies an interpolation algorithm to the rotated bitmap 40 to correct the black pixel. However, this can result in a fall in the rate of digital calculation due to features of the interpolation algorithm performed by the interpolation engine 30.

Consequently, the conventional bitmap rotation system performs calculation using real number data for all of the pixels of the source bitmap 10 and performs after-correction using the interpolation algorithm, so it takes a considerable time to calculate bitmap rotation.

### SUMMARY OF THE INVENTION

The present general inventive concept provides an image conversion apparatus having a rapid calculation rate by applying Bresenham's line algorithm to bitmap rotation, and an image conversion method thereof.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept are achieved by providing an apparatus to rotate a bitmap image, the apparatus including an edge information calculator to calculate information on an edge of a rotated bitmap corresponding to a predetermined edge of a source bitmap using bitmap information, a line information calculator to calculate line information to generate the rotated bitmap using the edge information of the rotated bitmap, and a bitmap generator to generate a final rotated bitmap using the edge information of the rotated bitmap and the line information.

The bitmap information may include a rotation angle to rotate the source bitmap, a size of the source bitmap, a size of the rotated bitmap, a color of the source bitmap, and pixel information corresponding to the source bitmap.

The apparatus further may further include a coordinates extractor to extract corner coordinates of the edge of the source bitmap using the bitmap information.

The edge information calculator may calculate the edge information of the rotated bitmap according to the equation below:

X=x×Cos(T)+y×Sin(T)

Y=−x×Sin(T)+y×Cos(T)

wherein (x,y) are corner coordinates of the edge of the source bitmap, T is a rotation angle to rotate the source bitmap, and (X,Y) the corner coordinates of the edge of the rotated bitmap corresponding to the corner coordinates of the edge of the source bitmap.

The edge of the source bitmap may include a first edge and a second edge which are adjacent to each other in the source bitmap.

The edge information calculator may calculate first, second, and third corner coordinates corresponding to coordinates of a contact point of the first edge and the second edge, coordinates of another corner of the first edge, and coordinates of another corner of the second edge.

The apparatus may further include an extended table generator to generate an extended table, in which pixels of the source bitmap are repeated a predetermined numbers of times, considering the size of the source bitmap and the rotated bitmap.

The line information calculator may calculate a Bresenham factor for the edge information, and may calculate the line information with reference to the Bresenham factor.

The line information may include a direction and a distance of movement of a line to generate a line constituting third and fourth edges which are adjacent to each other in the rotated bitmap.

The line information calculator may recalculate the distance of movement whenever the direction of movement changes.

The bitmap generator may repeat an operation of mapping the source bitmap to the rotated bitmap corresponding to the distance of movement along the direction of movement of the line.

The foregoing and/or other aspects and utilities of the present general inventive concept may also be achieved by providing a method of rotating a bitmap image, the method comprising, calculating information on an edge of a rotated bitmap corresponding to a predetermined edge of a source bitmap using bitmap information, calculating line information to generate the rotated bitmap using the edge information of the rotated bitmap, and generating a final rotated bitmap using the edge information of the rotated bitmap and the line information.

The bitmap information may include a rotation angle to rotate the source bitmap, a size of the source bitmap, a size of the rotated bitmap, a color of the source bitmap, and pixel information corresponding to the source bitmap.

The method may further include extracting corner coordinates of the edge of the source bitmap using the bitmap information.

The calculating of the edge information may include the edge information of the rotated bitmap being calculated according to the equation below:

X=x×Cos(T)+y×Sin(T)

Y=−x×Sin(T)+y×Cos(T)

wherein (x,y) are the corner coordinates of the edge of the source bitmap, T is the rotation angle to rotate the source bitmap, and (X,Y) are the corner coordinates of the edge of the rotated bitmap corresponding to the corner coordinates of the edge of the source bitmap.

The edge of the source bitmap may include a first edge and a second edge which are adjacent to each other in the source bitmap.

The calculating the edge information may include first, second, and third corner coordinates corresponding to coordinates of a contact point of the first edge and the second edge, coordinates of another corner of the first edge, and coordinates of another corner of the second edge may be calculated.

The method may further include generating an extended table, in which pixels of the source bitmap are repeated a predetermined number of times, taking into consideration the size of the source bitmap and the rotated bitmap.

The calculating of the line information may include calculating the Bresenham factor for the edge information, and calculating the line information with reference to the Bresenham factor.

The line information may include a direction and a distance of movement of a line to generate a line constituting third and fourth edges which are adjacent to each other in the rotated bitmap.

The calculating the of the Bresenham factor may include, a moving a direction and distance of movement of a line to generate the line constituting third and fourth edges which are adjacent to each other in the rotated bitmap are calculated. The calculating the line information further comprises recalculating the movement distance whenever the moving direction changes.

The generating of the final rotated bitmap may include the operation of mapping the source bitmap to the rotated bitmap corresponding to the movement distance along the direction of movement of the line being repeated.

The foregoing and/or other aspects and utilities of the present general inventive concept may also be achieved by providing an apparatus to rotate a source bitmap, the apparatus comprising a line information calculator to calculate a Bresenham factor for an edge of a rotated bitmap corresponding to the source bitmap, and to calculate line information with reference to the Bresenham factor, and a bitmap generator to generate a final rotated bitmap based on the calculations from the line information calculator.

The bitmap generator may generate the final rotated bitmap by moving pixels of the source bitmap in horizontal and diagonal directions.

The apparatus may further include an extended table generator to generate an extended table in which the pixels of the source bitmap are repeated a predetermined numbers of times, considering the size of the source bitmap and the rotated bitmap.

The foregoing and/or other aspects and utilities of the present general inventive concept may also be achieved by providing a method of rotating a source bitmap, the method including calculating a Bresenham factor for an edge of a rotated bitmap corresponding to the source bitmap, calculating line information with reference to the Bresenham factor, and generating a final rotated bitmap based on all the calculations.

The method may further include generating the final rotated bitmap by moving pixels of the source bitmap in horizontal and diagonal directions.

The method may further include generating an extended table in which the pixels of the source bitmap are repeated a predetermined numbers of times, considering the size of the source bitmap and the rotated bitmap.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a view illustrating a conventional bitmap rotation system;

FIG. 2 is a view illustrating a coordinates conversion error in a conventional bitmap rotation system;

FIG. 3 is a block diagram of an image conversion apparatus according to an exemplary embodiment of the present general inventive concept;

FIG. 4 is a schematic diagram illustrating a source bitmap and a rotated bitmap;

FIG. 5 illustrates movement of a point in an integer coordinates space;

FIGS. 6A-6B illustrate a result of bitmap mapping of a straight line;

FIG. 7 illustrates line generation in the integer coordinates space;

FIG. 8 illustrates a line generated using Bresenham's line algorithm;

FIGS. 9A-9C illustrate an extended table generated by the extended table generator of FIG. 3;

FIG. 10 illustrates a final bitmap rotated by the bitmap generator of FIG. 3; and

FIG. 11 is a flow chart illustrating an image conversion method according to an exemplary embodiment of the present general inventive concept.

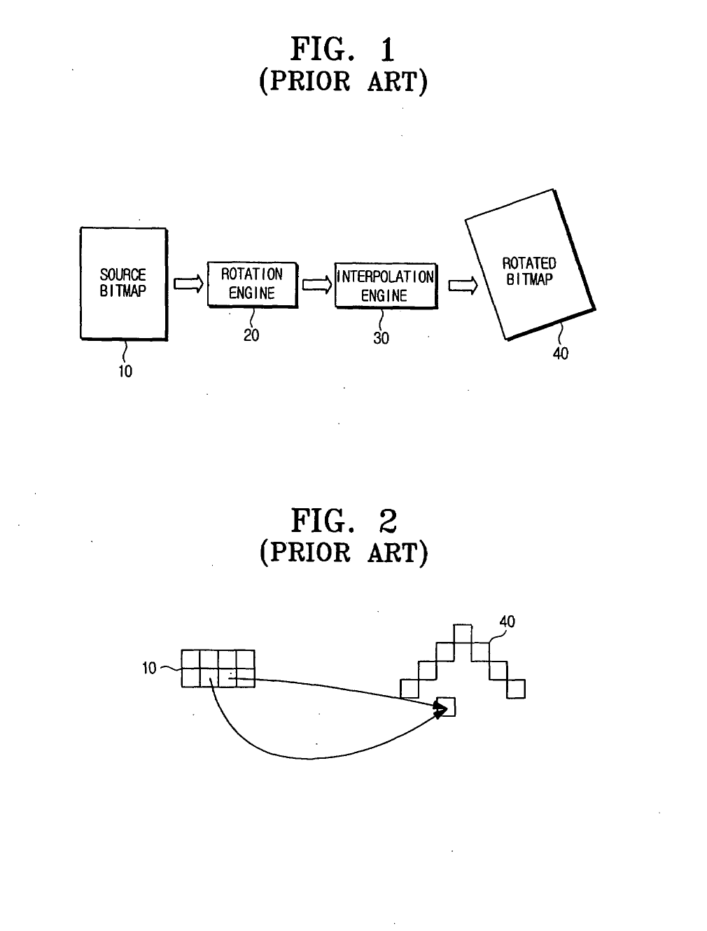

Throughout the drawings, the same drawing reference numerals will be understood to refer to the same elements, features, and structures.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

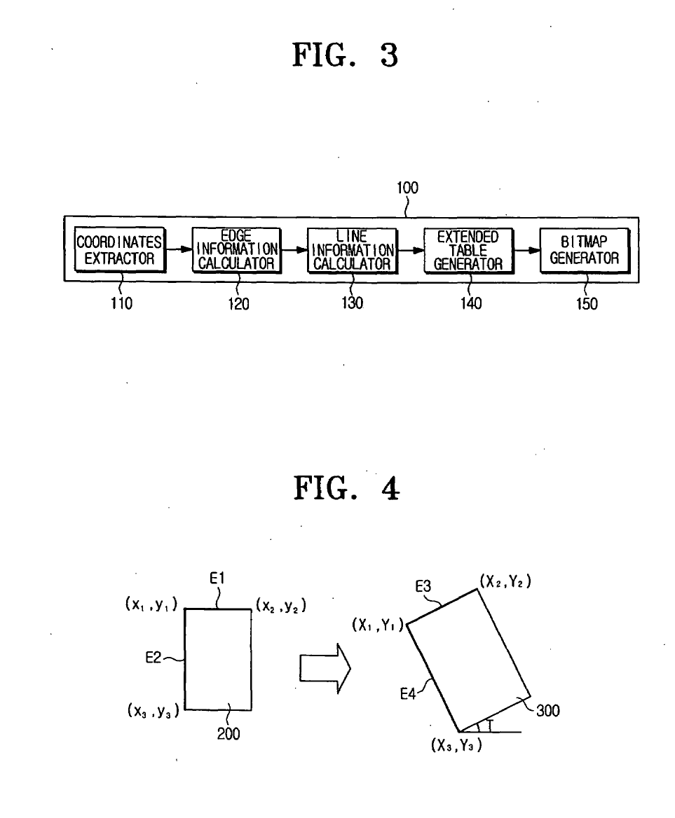

FIG. 3 is a block diagram of an image conversion apparatus according to an exemplary embodiment of the present general inventive concept, and FIG. 4 is a schematic diagram illustrating a source bitmap and a rotated bitmap.

In FIG. 3, a bitmap image rotation apparatus 100 according to an exemplary embodiment of the present general inventive concept includes a coordinates extractor 110, an edge information calculator 120, a line information calculator 130, an extended table generator 140 and a bitmap generator 150.

Referring to FIGS. 3 and 4, the coordinates extractor 110 extracts corner coordinates of one edge of a source bitmap 200 using bitmap information, and provides the corner coordinates to the edge information calculator 120.

The bitmap information may include a rotation angle to rotate the source bitmap 200, a size of the source bitmap 200, a size of the rotated bitmap 300, a color of the source bitmap 200, and pixel information corresponding to the source bitmap 200. If the bitmap image rotation apparatus 100 is a computer, the bitmap information is provided from the window Graphics Device Interface (GDI) to the coordinates extractor 110.

The certain edge of the source bitmap 200 refers to the first and second edges which are adjacent to each other in the source bitmap 200. In FIG. 4, an upper edge of the source bitmap 200 is a first edge E1 and a edge adjacent to the first edge E1 in the drawing is a second edge E2. The first edge E1 and the second edge E2 contact each other to form a corner, so the coordinates of the corners overlap.

Accordingly, the coordinates extractor 110 extracts coordinates (x1,y1) of the contact point of the first edge E1 and the second edge E2, coordinates (x2,y2) of another corner of the first edge E1, and coordinates (x3,y3) of another corner of the second edge E2.

The bitmap information may include coordinates of other corners of the first edge E1 and the second edge E2 of the source bitmap 200. Accordingly, the coordinates extractor 110 is not needed.

The edge information calculator 120 calculates edge information of the rotated bitmap 300 corresponding to one edge of the source bitmap 200 using the bitmap information or the coordinates of the corners of the edges provided from the coordinates extractor 110.

The edge information calculator 120 calculates the edge information of the rotated bitmap 300 using Equation 4, where (x,y) are the coordinates of one corner of the source bitmap 200, T is the rotation angle to rotate the source bitmap 200, and (X,Y) are corner coordinates of the rotated bitmap 300 corresponding to corner coordinates of an edge of the source bitmap 200. Equation 4 illustrates a clockwise coordinates conversion as follows.

X=x×Cos(T)+y×Sin(T)

Y=−x×Sin(T)+y×Cos(T) [Equation 4]

The edge information calculator 120 calculates the first, second, and third corner coordinates of the rotated bitmap 300 corresponding to the corners of the source bitmap 200, using the corner coordinates of an edge of the source bitmap 200, which are extracted by the coordinates extractor 110.

The edge information calculator 120 calculates only the first, second, and third corner coordinates of the rotated bitmap 300 corresponding to the corners of the source bitmap 200, so a rate of bitmap rotation calculation according to an embodiment of the present general inventive concept is the same when compared to a conventional method to calculate coordinates of all of the pixels.

The coordinates extracted by the coordinates extractor 110 are the coordinates (x1,y1) of the contact point of the first edge E1 and the second edge E2, the coordinates (x2,y2) of another corner of the first edge E1, and the coordinates (x3,y3) of another corner of the second edge E2. Accordingly, the edge information calculator 120 calculates corner coordinates (X1,Y1), (X2,Y2) and (X3,Y3) of a third edge E3 and a fourth edge E4 of the rotated bitmap 300 using Equation 4.

A method to calculate the corner coordinates (X1,Y1), (X2,Y2) and (X3,Y3) of the third edge E3 and the fourth edge E4 of the rotated bitmap 300 in the edge information calculator 120 using Equation 4 is arranged in Equation 5.

The third edge E3 and the fourth edge E4 of the rotated bitmap 300 are the edges generated by rotating the first edge E1 and the second edge E2 of the source bitmap 200, and thus correspond to the first edge E1 and the second edge E2 of the source bitmap 200, respectively. Furthermore, each of the corners of the third edge E3 and the fourth edge E4 of the rotated bitmap 300 indicates the first, second, and third corners.

X₁=x₁×Cos(T)+y₁×Sin(T)

Y₁=−x₁×Sin(T)+y₁×Cos(T)

X₂=x₂×Cos(T)+y₂×Sin(T)

Y₂=−x₂×Sin(T)+y₂×Cos(T)

X₃=x₃×Cos(T)+y₃×Sin(T)

Y₃=−x₃×Sin(T)+y₃×Cos(T)

The line information calculator 130 calculates line information of the rotated bitmap 300, using the edge information of the rotated bitmap 300 which is calculated by the edge information calculator 120. The line information includes a moving direction and a movement distance of a line to generate the line constituting the third edge E3 and the fourth edge E4, which are adjacent to each other in the rotated bitmap.

The line information calculator 130 may calculate the Bresenham factor corresponding to the edge information and calculate the line information with reference to the Bresenham factor.

Moreover, the line information calculator 130 recalculates the movement distance each time the moving direction of the line changes, and the recalculated movement distance is applied to generate a final rotated bitmap.

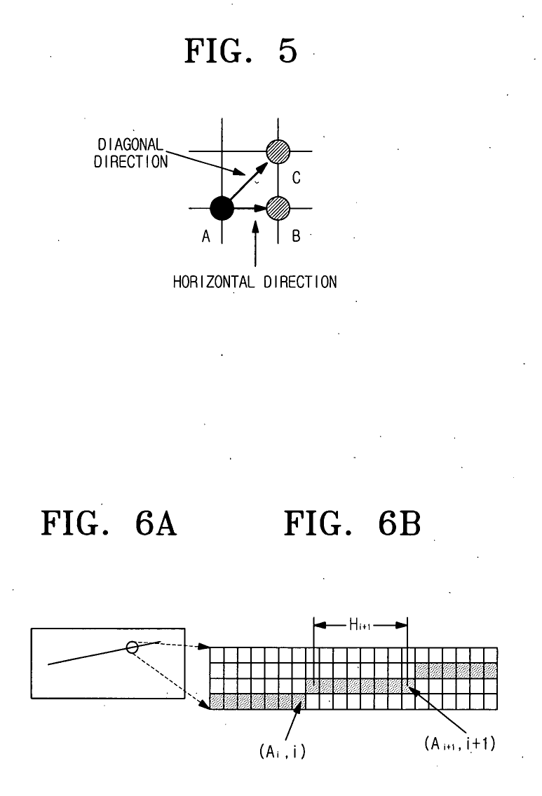

The Bresenham factor calculated by the line information calculator 130 is used to rotate the source bitmap 200 using Bresenham's line algorithm, which is described in detail below with reference to FIGS. 5-7.

The extended table generator 140 generates an extended table, in which pixels of the source bitmap 200 are repeated a predetermined number of times, taking into consideration the size of the source bitmap 200 and the rotated bitmap 300 among the bitmap information. The extended table generator 140 is described in detail below with reference to FIG. 8.

The bitmap generator 150 generates a final rotated bitmap using the edge information calculated by the edge information calculator 120, that is, corner coordinates of the rotated bitmap and the line information calculated by the line information calculator 130.

The bitmap generator 150 maps each pixel of the source bitmap 200 to corresponding pixel of the rotated bitmap 300, if the ratio of the size of the source bitmap 200 to the rotation bitmap 300 is 1:1. However, if the size of the rotation bitmap 300 is larger than that of the source bitmap 200, the source bitmap 200 is mapped to the rotated bitmap 300 using the extended table generated by the extended table generator 140.

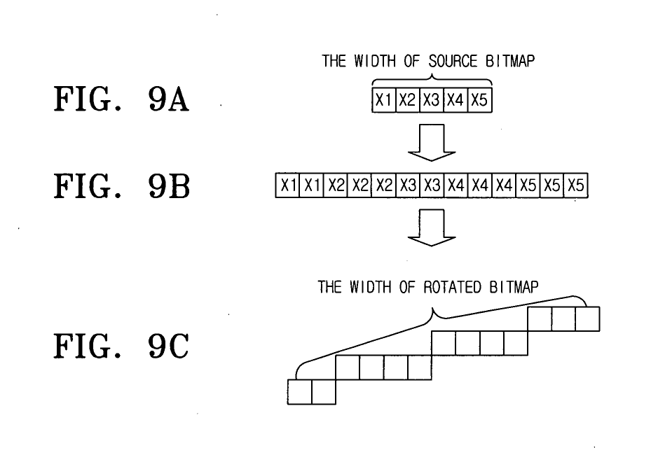

The bitmap generator 150 repeats the operation of mapping the source bitmap 200 to the rotated bitmap 300 by moving a distance corresponding to the movement distance along the moving direction of the line determined by the line information calculator 130. The bitmap generator 150 is described in detail below with reference to FIG. 9.

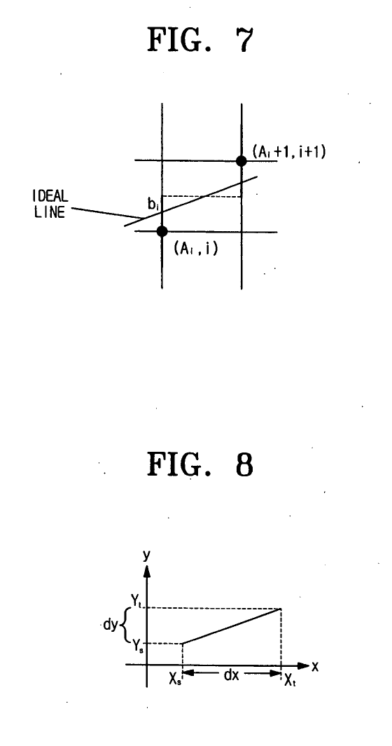

FIG. 5 illustrates movement of a point in an integer coordinates space, FIGS. 6A-6B illustrate a result of bitmap mapping of a straight line, FIG. 7 illustrates line generation in the integer coordinates space, and FIG. 8 illustrates a line generated using Bresenham's line algorithm.

Referring to FIGS. 5-8, Bresenham's line algorithm, which decides the Bresenham factor referred to calculate the line information in the line information calculator 130, is described.

Bresenham line generation, as was described in “Algorithms for computer control of a digital plotter” in 1965, includes a method in which an enhanced calculation rate caused by not performing real number calculation is compared to a conventional line generation method.

Furthermore, in 1985, Bresenham published “Run length slice algorithms for incremental lines,” describing a method with a calculation rate having enhancements over the method published in 1965. The Bresenham factor calculated by the line information calculator 130 follows the line generation method published in 1985. Therefore, the line generation method published in 1965 is omitted, and the line generation method published in 1985 is described here.

With reference to FIG. 5, movement from one point to another point may be either in a horizontal direction or a diagonal direction.

Accordingly, as illustrated in FIG. 5, a current point A can move to a point B or a point C. The slope of the line may have an angle smaller than Tan⁻¹(½), and a line which connects point A to point B or point A to point C rises from left to right, that is, in a direction of an increasing x-value.

Based on the above premise, a result of bitmap memory mapping of a digitalized straight line used to draw a straight line of FIG. 6A is illustrated in FIG. 6B. As illustrated in FIG. 6B, the straight line is mapped by repeatedly moving in a horizontal direction for a certain distance, moving in a diagonal direction at a certain point, and then moving in a horizontal direction again for a certain distance. If a rule by which diagonal movement occurs is known, a number of calculations can be fewer than in the line generation method published in 1965.

Referring to FIG. 6B, when a pixel has initial coordinates (Ai, i), a movement in a diagonal direction is performed if a position of another pixel is (Ai+1, I+1). When a value of 1 is added to a pixel's y value, the y value increases and movement in a diagonal direction occurs.

FIG. 7 illustrates an ideal line in the integer coordinates space of FIG. 5. Movement in a diagonal direction occurs by selecting a next pixel following a coordinate (Ai, i). Assuming that an x-axis coordinate Ai has a value between 0 and dx, and the y-axis coordinates i has a value between 0 and dy, a y-axis value bi corresponding to a median of x coordinates Ai and Ai+1 can be calculated using Equation 6.

$${b}_{i} = i + 0.5 = \frac{( 1 + 2 i )}{2} , i = 0 , 1 , … , ( dy - 1 ) \qquad [ Equation 6 ]$$

If an equation representing a straight line y=(dy/dx)x is substituted into Equation 6, with bi representing y-axis coordinates, the x-axis coordinates can be calculated using Equation 7 to indicates the x-axis coordinates of the lower left hand pixel prior to a movement in a diagonal direction.

$$x = \frac{d x ( 1 + 2 i )}{2 d y} , i = 0 , 1 , … , ( dy - 1 ) \qquad [ Equation 7 ]$$

As x is a real number which varies according to the variable i, if it is assumed that a digitalized x value is Ai, the x value Ai can be calculated in FIG. 6. Accordingly, INT[x] is defined as the largest integer which does not exceed x. For example, INT[2.5] is 2. Simplified equations are given below in Equation 8.

$$Q = INT [ \frac{d x}{d y} ] , 1 \leq Q \leq dx \\ R = dx \% dy , 0 \leq R \leq ( dy - 1 ) \\ M = INT [ \frac{d x}{2 d y} ] , M = ( Q ≫ 1 ) \\ N = dx \%2 dy , if Q is even N = R , otherwise N = R + dy \\ {T}_{i} = ( N + 2 Ri ) \%2 dy , 0 \leq i \leq ( dy - 1 ) \\ {T}_{o} = N \\ if ( {T}_{i} + 2 R ) < 2 dy , {T}_{i + 1} = 2 R \\ if ( {T}_{i} + 2 R ) \geq 2 dy , {T}_{i + 1} = 2 R - 2 dy \\ {S}_{i} = INT [ \frac{( N + 2 Ri )}{2 dy} ] , 0 \leq i \leq ( dy - 1 ) \\ {S}_{0} = 0 , {S}_{i + 1} = {S}_{i} + INT [ \frac{( {T}_{i} + 2 R )}{2 dy} ] \\ {S}_{i + 1} = {S}_{i} , if ( {T}_{i} + 2 R ) < 0 \\ {S}_{i + 1} = {S}_{i} + 1 , if ( {T}_{i} + 2 R ) \geq 2 dy \qquad [ Equation 8 ]$$

Ai can be calculated using Equation 8 as illustrated in Equation 9.

$${A}_{i} = INT [ \frac{d x ( 1 + 2 i )}{2 d y} ] = INT [ ( \frac{d x}{2 d y} ) + ( \frac{i d x}{d y} ) ] \\ {A}_{i} = INT [ ( \frac{d x}{2 d y} ) + ( \frac{i d x}{d y} ) ] \\ {A}_{i} = M + iQ + INT [ \frac{( N + 2 Ri )}{2 dy} ] \qquad [ Equation 9 ]$$

The distance of the horizontal movement Hi+1 in FIG. 6 can be calculated using Equation 9 as illustrated in Equation 10.

$${H}_{i + 1} = {A}_{i + 1} - {A}_{i} - 1 \\ {H}_{i + 1} = ( M + ( i + 1 ) Q + INT [ \frac{N + 2 ( i + 1 ) R}{2 dy} ] ) - ( ( M + iQ + INT [ \frac{N + 2 iR}{2 dy} ] ) - 1 ) \\ {H}_{i + 1} = Q + INT [ \frac{( N + 2 Ri )}{2 dy} + \frac{2 R}{2 dy} ] - INT [ \frac{( N + 2 iR )}{2 dy} ] - 1 \\ {H}_{i + 1} = Q + {S}_{i} + INT [ \frac{{T}_{i} + 2 R}{2 dy} ] - ( {S}_{i} + INT [ \frac{{T}_{i}}{2 dy} ] ) - 1 \\ {H}_{i + 1} = Q - 1 + INT [ \frac{{T}_{i} + 2 R}{2 dy} ] \qquad [ Equation 10 ]$$

Equation 11 can be derived from Equation 10.

Hᵢ₊₁=Q if (Tᵢ+2R)≧2dy

Hᵢ₊₁=Q−1 if (Tᵢ+2R)<2dy [Equation 11]

Accordingly, the movement distance Hi+1 can be Q or Q−1 depending on the value of (Ti+2R) and 2dy. Equation 12 is based on Di, which determines the size of horizontal movement, being (Ti+2R)−2dy.

if Dᵢ<0 use Hᵢ=Q−1 and update Dᵢ₊₁=Dᵢ+2R or

if Dᵢ≧0 use Hᵢ=Q and update Dᵢ₊₁=Dᵢ+2R−2dy

D₁=N+2R−2dy [Equation 12]

The movement distance H0 of the initial point can be calculated using Equation 13.

$${H}_{0} = {A}_{0} = INT [ \frac{d x}{2 d y} ] = INT [ M + \frac{N}{2 dy} ] = M + INT [ \frac{N}{2 dy} ] = M \qquad [ Equation 13 ]$$

The movement distance Hdy of the final point can be calculated using Equation 14.

$${A}_{dy - 1} = INT [ \frac{( 1 + 2 ( dy - 1 ) ) dx}{2 dy} ] = INT [ dx - \frac{d x}{2 d y} ] = INT [ dx - ( M + \frac{N}{2 dy} ) ] = ( dx - M ) + INT [ - ( \frac{N}{2 dy} ) ] \\ {H}_{dy} = dx - {A}_{dy - 1} - 1 = M - 1 if N = 0 or \\ {H}_{dy} = dx - {A}_{dy - 1} - 1 = M if N \neq 0 \qquad [ Equation 14 ]$$

The above equation is based on a slope of the line being Tan⁻¹(½). When the slope of the line is between Tan⁻¹(½) and 45°, the above assumption can be generalized for all slopes.

Application of the above equations to a slope between 45° and 90° is permitted by swapping x with y in the above equations, which assume a slope between 0° and 45°, and the application of the above equations to other quadrants is permitted by applying the corresponding rules governing the relationship of lines in those quadrants with lines between 0° and 90°.

In a line meeting a condition of dy<dx<2dy, Q is always 1 and M is always 0. This means that horizontal movement is always 1 or 0, so the distance of movement is not meaningful.

However, a line having a slope of dy/dx between 0° and Tan⁻¹(½) is exactly symmetrical with a line having a slope of dx/(dx-dy) between Tan⁻¹(½) and 45°. Horizontal movement and diagonal movement of a line having a slope between 0° and Tan⁻¹(½) maps exactly with horizontal movement and diagonal movement of a line having a slope between Tan⁻¹(½) and 45°.

FIG. 8 illustrates a general octant line which begins at coordinates (Xs,Ys) and ends at coordinates (Xt,Yt). Bresenham's line algorithm, described using FIGS. 5-7, is more easily explained by referring to FIG. 8.

Referring to FIGS. 3-8, the line information calculator 130 can calculate line information in order to generate the rotated bitmap 300 by the Bresenham factor calculated using Bresenham's line algorithm. Accordingly, lines can be generated in all directions of the rotated bitmap 300 using the Bresenham factor.

FIGS. 9A-9C illustrate an extended table generated using the extended table generator 140 of FIG. 3.

Referring to FIGS. 3-9C, if the source bitmap 200 and the rotated bitmap 300 have a same width and height, an extended table does not need to be generated by the extended table generator 140.

However, the source bitmap 200 and the rotated bitmap 300 do not always have the same width and height. For example, the printer may generate the rotated bitmap 300 by stretching the source bitmap 200.

FIG. 9A illustrates a portion of the source bitmap 200. The extended table generator 140 extends the portion of the source bitmap 200 of FIG. 9A to become an extended table, where each of the pixels are repeated a certain number of times as illustrated in FIG. 9B. As the method of generating the extended table is the same as a conventional image scaling method to reduce or extend an image, a detailed description of the method is omitted.

As illustrated in FIG. 9C, a width of the rotated bitmap 300 corresponds to a length of a diagonal line, rather than 13 pixels, as illustrated in FIG. 9B. The stretched 1 pixel bitmap of FIG. 9B is an intermediate bitmap that is generated when the width of the source bitmap of FIG. 9A and the width of the rotated bitmap of FIG. 9C in the extended table generator 140 are taken into consideration. That is, the intermediate bitmap that has a width of 13 of FIG. 9B is mapped to the bitmap of FIG. 9C. In this case, the width of the rotated bitmap of FIG. 9C is not 13 pixels.

The extended table generator 140 can obtain a stretching factor corresponding to each pixel of FIG. 9A by considering a ratio of the width of the source bitmap of FIG. 9A and the width of the rotated bitmap of FIG. 9C, to generate the intermediate bitmap of FIG. 9B from the source bitmap of FIG. 9A.

The extended table generator 140 can store the stretching factors in a mapped space as wide as the source bitmap illustrated in FIG. 9A. If values 2, 3, 2, 3, and 3 are stored, the intermediate bitmap of FIG. 9B can be generated using ratios corresponding to two times X1, three times x2, two times X3, three times X4, and three times X5. In this exemplary embodiment, only x-axis stretching is described, but pixel values to stretch the y-axis can also be obtained using the methods described above.

The extended table generated by the extended table generator 140 includes information obtained before rotating the source bitmap 200, and does not fully affect bitmap rotation calculation. Accordingly, a conventional additional interpolation is not needed after rotating the bitmap.

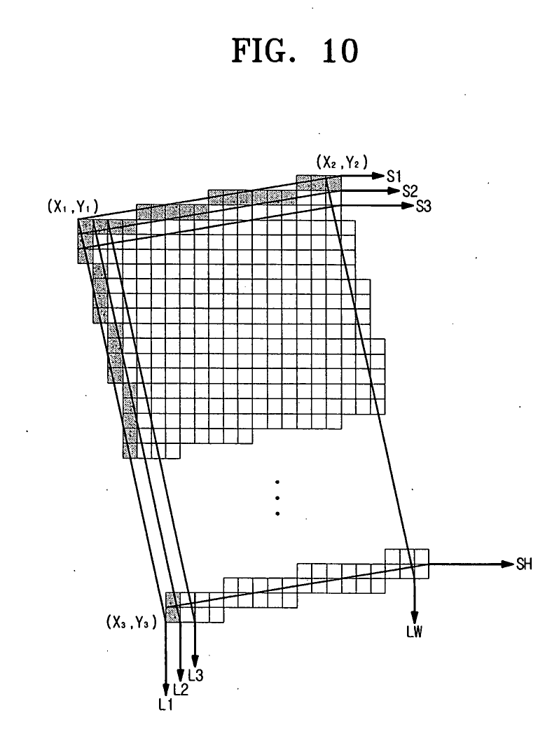

FIG. 10 illustrates a final bitmap rotated by the bitmap generator 150 of FIG. 3.

Referring to FIGS. 3, 4, and 10, the bitmap generator 150 maps the extended table generated by the extended table generator 140 to the rotated bitmap 300. The bitmap generator 150 maps the extended table with the rotated bitmap 300 along the line connecting the first to third corners with reference to the first to third corner coordinates (X1,Y1), (X2,Y2) and (X3,Y3) of the rotated bitmap 300 calculated by the edge information calculator 120.

In FIG. 10, a line S1 connects a first corner and a second corner, and lines located 1 pixel below line S1 along the y-axis include lines S2, S3, . . . , SH. Also, a line L1 connects the first corner and a third corner, and lines located 1 pixel to the right of line L1 along the x-axis include lines L2, L3, . . . , LW.

The bitmap generator 150 maps the bitmap with reference to the Bresenham factor calculated by the line information calculator 130 in the direction of the line S1, as much as the corresponding movement. FIG. 10 illustrates the movement distance being updated to include values of 4, 5, 6, and 3 whenever diagonal movement occurs in the direction of the line S1.

The bitmap generator 150 maps the bitmap along the line S1, then moves by one pixel along the line L1, then again maps the bitmap along the line S2 with a movement distance of 4, 5, 6, and 3.

That is, the bitmap generator 150 maps 4 pixels in the horizontal direction along the horizontal line S1, maps 5 pixels horizontally after moving 1 pixel diagonally, maps 6 pixels horizontally after moving 1 pixel diagonally, and maps 3 pixels horizontally after moving 1 pixel diagonally. Subsequently, the bitmap generator 150 moves to line S2 to map the same movement distance. This process is repeated up to line SH.

After the bitmap generator 150 maps all of the bitmap with a movement distance of 4, 5, 6, and 3 from the line S1 to the line SH, the source bitmap 200 is converted to the final rotated bitmap 300 which is rotated at a certain angle as illustrated in FIG. 4.

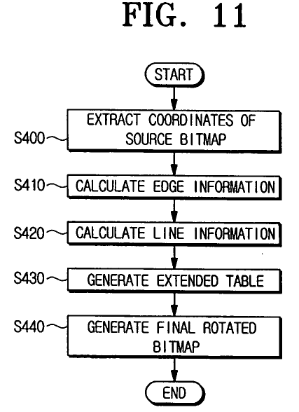

FIG. 11 is a flow chart illustrating an image conversion method according to an exemplary embodiment of the present general inventive concept.

Hereinafter, the image conversion method according to an exemplary embodiment of the present general inventive concept is described with reference to FIGS. 3-11.

The coordinates extractor 110 extracts corner coordinates of a certain edge of the source bitmap 200 using the bitmap information. In operation S400, the coordinates extractor 110 extracts each pair of corner coordinates (x1,y1), (x2,y2) and (x3,y3) of the first edge E1 and the second edge E2 of the source bitmap 200 as illustrated in FIG. 4.

In operation S410, the edge information calculator 120 calculates the edge information of the rotated bitmap 300 using the bitmap information or the extracted corner coordinates (x1,y1), (x2,y2) and (x3,y3). At this time, the edge information calculator 120 calculates the edge information of the rotated bitmap 300 using Equation 4. Referring to FIG. 4, the edge information of the rotated bitmap 300 calculated by the edge information calculator 120 includes the coordinates (X1,Y1), (X2,Y2) and (X3,Y3).

In operation S420, the line information calculator 130 calculates the Bresenham factor for the edge information using the calculated edge information of the rotated bitmap 300, and determines the direction and distance of movement for bitmap mapping with reference to the Bresenham factor.

The extended table generator 140 generates the extended table where pixels of the source bitmap 200 are repeated a certain number of times taking into consideration the size of the source bitmap 200 and rotated bitmap 300 in operation S430. If the ratio of the size of the source bitmap 200 and rotated bitmap 300 is 1:1, operation S430 is not needed.

The bitmap generator 150 maps the extended table with the rotated bitmap 300 along the direction of the lines S1, S2, S3, . . . , SH in order, as illustrated in FIG. 10. Generation of the final rotated bitmap 300 in the bitmap generator 150 follows the same operation as illustrated in FIG. 10 (S440).

To explain the effects of the present general inventive concept, Table 1 illustrates the results of simulating the calculation rate in the cases of bitmap rotation using the Bresenham factors published in 1965 and in 1985.

A first condition of the simulation includes initial coordinates of the bitmap being (0, 0) and the simulation is repeated several times by altering the location of the highest line to enhance the reliability.

A second condition of the simulation includes simulating a bitmap of about ¼, 2/4, ¾ and 4/4 size of A4 paper. The A4 paper has a width of about 4800 pixels and a height of about 6400 pixels.

A third condition of the simulation includes simulating a large bitmap. For example, the bitmap used in this simulation has a width of 20000 and a height of 100000.

A fourth condition of the simulation includes simulating rotation of 18-20 bitmaps having slopes of between 0° and 45° while changing the y-coordinates by a width of half a bitmap at a time.

TABLE 1

| | Using the | Using the | |
|---|---|---|---|
| | Bresenham factor | Bresenham factor | |
| Bitmap size | published in 1965 | published in 1985 | Rate |
| 1000 × 6000 | 721 | 451 | |
| | 642 | 515 | |
| | 688 | 469 | |
| | 764 | 392 | |
| Subtotal | 5886 | 3879 | 1.517401 |
| 2000 × 6000 | 1438 | 984 | |
| | 1421 | 1016 | |
| | 1512 | 956 | |
| | 1515 | 923 | |
| Subtotal | 5886 | 3879 | 1.517401 |
| 3000 × 6000 | 2252 | 1592 | |
| | 2299 | 1545 | |
| | 2360 | 1531 | |
| | 2300 | 1559 | |
| Subtotal | 9211 | 6227 | 1.479203 |
| 4000 × 6000 | 3014 | 2111 | |
| | 3030 | 2095 | |
| | 3079 | 2077 | |
| | 3046 | 2079 | |
| Subtotal | 12169 | 8362 | 1.455274 |
| 20000 × 100000 | 254764 | 172079 | |
| | 253625 | 172344 | |
| | 255280 | 173564 | |
| | 253420 | 171689 | |
| Subtotal | 1017089 | 689676 | 1.474735 |
| Total | 1047170 | 709971 | 1.474948 |

Unit: ms

Table 1 can be obtained by repeating a simulation according to the above four conditions. As illustrated in Table 1, using the Bresenham factor published in 1985 has a calculation rate enhanced by 45% more than the Bresenham factor published in 1965.

A bitmap image rotation apparatus using the above bitmap image rotation method may be any of a wide range of apparatuses using bitmap images such as multimedia display apparatuses, application programs for games or print apparatuses.

A bitmap image rotation apparatus and a bitmap image rotation method according to the present general inventive concept have may improve a rotation calculation rate of a bitmap image by performing integer calculation of bitmap rotation calculation using Bresenham's line algorithm.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An apparatus to rotate a bitmap image, the apparatus comprising:
an edge information calculator to calculate information on an edge of a rotated bitmap corresponding to a predetermined edge of a source bitmap using bitmap information;
a line information calculator to calculate line information to generate the rotated bitmap using the edge information of the rotated bitmap; and
a bitmap generator to generate a final rotated bitmap using the edge information of the rotated bitmap and the line information.

2. The apparatus of claim 1, wherein the bitmap information comprises:
a rotation angle to rotate the source bitmap;
a size of the source bitmap;
a size of the rotated bitmap;
a color of the source bitmap; and
pixel information corresponding to the source bitmap.

3. The apparatus of claim 1, further comprising:
a coordinates extractor to extract corner coordinates of the edge of the source bitmap using the bitmap information.

4. The apparatus of claim 1, wherein the edge information calculator calculates the edge information of the rotated bitmap according to the equation below:
X=x×Cos(T)+y×Sin(T)
Y=−x×Sin(T)+y×Cos(T)
wherein (x,y) are corner coordinates of the edge of the source bitmap, T is a rotation angle to rotate the source bitmap, and (X,Y) are corner coordinates of the edge of the rotated bitmap corresponding to the corner coordinates of the edge of the source bitmap.

5. The apparatus of claim 1, wherein the edge of the source bitmap comprises:
a first edge and a second edge which are adjacent to each other in the source bitmap.

6. The apparatus of claim 5, wherein the edge information calculator calculates first, second, and third corner coordinates corresponding to coordinates of a contact point of the first edge and the second edge, coordinates of another corner of the first edge, and coordinates of another corner of the second edge.

7. The apparatus of claim 2, further comprising:
an extended table generator to generate an extended table, in which pixels of the source bitmap are repeated a predetermined numbers of times, considering the size of the source bitmap and the rotated bitmap.

8. The apparatus of claim 1, wherein the line information calculator calculates a Bresenham factor for the edge information, and calculates the line information with reference to the Bresenham factor.

9. The apparatus of claim 8, wherein the line information comprises:
a direction and a distance of a movement of a line to generate a line constituting third and fourth edges which are adjacent to each other in the rotated bitmap.

10. The apparatus of claim 9, wherein the line information calculator recalculates the distance of movement whenever the direction of movement changes.

11. The apparatus of claim 10, wherein the bitmap generator repeats an operation of mapping the source bitmap to the rotated bitmap corresponding to the distance of movement along the direction of movement of the line.

12. A method of rotating a bitmap image, the method comprising:
calculating information on an edge of a rotated bitmap corresponding to a predetermined edge of a source bitmap using bitmap information;
calculating line information to generate the rotated bitmap using the edge information of the rotated bitmap; and
generating a final rotated bitmap using the edge information of the rotated bitmap and the line information.

13. The method of claim 12, wherein the bitmap information comprises:
a rotation angle to rotate the source bitmap;
a size of the source bitmap;
a size of the rotated bitmap;
a color of the source bitmap; and
pixel information corresponding to the source bitmap.

14. The method of claim 12, further comprising:
extracting corner coordinates of the edge of the source bitmap using the bitmap information.

15. The method of claim 12, wherein in the calculating the edge information, the edge information of the rotated bitmap is calculated according to the equation below:
X=x×Cos(T)+y×Sin(T)
Y=−x×Sin(T)+y×Cos(T)
wherein (x,y) are the corner coordinates of the edge of the source bitmap, T is the rotation angle to rotate the source bitmap, and (X,Y) are the corner coordinates of the edge of the rotated bitmap corresponding to the corner coordinates of the edge of the source bitmap.

16. The method of claim 12, wherein the edge of the source bitmap comprises:
a first edge and a second edge which are adjacent to each other in the source bitmap.

17. The method of claim 16, wherein in the calculating the edge information, first to third corner coordinates corresponding to coordinates of a contact point of the first edge and the second edge, coordinates of another corner of the first edge, and coordinates of another corner of the second edge are calculated.

18. The method of claim 13, further comprising:
generating an extended table, in which pixels of the source bitmap are repeated a predetermined number of times, taking into consideration the size of the source bitmap and the rotated bitmap.

19. The method of claim 12, wherein the calculating the line information comprises:
calculating a Bresenham factor for the edge information; and
calculating the line information with reference to the Bresenham factor.

20. The method of claim 19, wherein the line information comprises:
a direction and a distance of movement of a line to generate a line constituting third and fourth edges which are adjacent to each other in the rotated bitmap.

21. The method of claim 19, wherein in the calculating the Bresenham factor, a moving a direction and distance of movement of a line to generate a line constituting third and fourth edges which are adjacent to each other in the rotated bitmap are calculated.

22. The method of claim 21, wherein the calculating the line information further comprises:
recalculating the movement distance whenever the moving direction changes.

23. The method of claim 22, wherein during the generating the final rotated bitmap, the operation of mapping the source bitmap to the rotated bitmap corresponding to the movement distance along the direction of movement of the line is repeated.

24. An apparatus to rotate a source bitmap, the apparatus comprising:
a line information calculator to calculate a Bresenham factor for an edge of a rotated bitmap corresponding to the source bitmap, and to calculate line information with reference to the Bresenham factor; and
a bitmap generator to generate a final rotated bitmap based on the calculations from the line information calculator.

25. The apparatus of claim 24, wherein the bitmap generator generates the final rotated bitmap by moving pixels of the source bitmap in horizontal and diagonal directions.

26. The apparatus of claim 25, further comprising:
an extended table generator to generate an extended table in which the pixels of the source bitmap are repeated a predetermined numbers of times, considering the size of the source bitmap and the rotated bitmap.

27. A method of rotating a source bitmap, the method comprising:
calculating a Bresenham factor for an edge of a rotated bitmap corresponding to the source bitmap;
calculating line information with reference to the Bresenham factor; and
generating a final rotated bitmap based on all the calculations.

28. The method of claim 27, further comprising:
generating the final rotated bitmap by moving pixels of the source bitmap in horizontal and diagonal directions.

29. The apparatus of claim 28, further comprising:
generating an extended table in which the pixels of the source bitmap are repeated a predetermined numbers of times, considering the size of the source bitmap and the rotated bitmap.
